(19) United States
(12) Patent Application Publication
(10) Pub. No.: US 2010/0295751 A1
(43) Pub. Date: Nov. 25, 2010

(54) Telescoping vertical antenna

(76) Inventor: Stephen H. Sheers, Proctorville, OH (US)

Correspondence Address: LITMAN LAW OFFICES, LTD., PATENT LAW BUILDING, 8955 CENTER STREET, MANASSAS, VA, 20110, US

(21) Appl. No.: 12/453,820

(22) Filed: May 22, 2009

(51) Int. Cl. H01Q 1/10

(52) U.S. Cl. 343/901

(57) ABSTRACT

The telescoping vertical antenna is a portable antenna that includes a hollow telescoping fiberglass pole that can be vertically erected to a height of about 31′ for use and collapsed to about 44″ for storage and transport. The device includes clamps that are used to attach the antenna to a mounting pole, ladder or any other secured objects on a motor home or car. The antenna can also be attached to a heavy-duty tripod. A flexible wire radiating element is attached on the inside of the hollow fiberglass pole, the radiating element extending along with the telescoping sections as they are pulled out. A clamp located on the bottom of the pole holds a coaxial cable connector for the antenna.

### BACKGROUND OF THE INVENTION

1. Field of the Invention

The present invention relates generally to radio antennas, and more particularly to a telescoping vertical antenna for 10 m-80 m.

2. Description of the Related Art

Amateur radio operators frequently participate in emergency radio-telecommunications activities and simulated emergency radio-telecommunications activities which often require that the telecommunications gear be portable and relatively easy to setup and break down. Moreover, it would be desirable to have radio gear that can be operational in a vehicle, thereby further enhancing the emergency telecommunications abilities of the amateur radio gear. The aforementioned desirable features are further enhanced by an antenna system that can be easily erected and broken-down by a single person. The antenna should be supportable by a tripod, RV ladder, and the like. Moreover, the antenna should present minimal hazard when radio personnel must erect the antenna near power lines. The antenna structure should be protective against harsh use conditions. The antenna should be operable to transmit and receive signals in a variety of High Frequency (HF) radio bands.

Thus, a telescoping vertical antenna solving the aforementioned problems is desired.

### SUMMARY OF THE INVENTION

The telescoping vertical antenna is a portable antenna that includes a hollow telescoping fiberglass pole that can be vertically erected to a height of 31′ and collapsed to about 44″ for storage and transport. The device includes clamps that are used to attach the antenna to a mounting pole, ladder or any other secured objects on a motor home or car. The antenna can also be attached to a heavy-duty tripod. A flexible radiating element is attached on the inside of the hollow fiberglass pole, the radiating element extending along with the telescoping sections as they are pulled out. A clamp located on the bottom of the pole holds a coaxial cable connector for the antenna.

These and other features of the present invention will become readily apparent upon further review of the following specification and drawings.

### BRIEF DESCRIPTION OF THE DRAWINGS

FIG. 1 is a perspective view of a telescoping vertical antenna according to the present invention, shown collapsed for storage or transport.

FIG. 2 is a perspective view of the telescoping vertical antenna of FIG. 1, shown collapsed but with selected parts exploded therefrom.

FIG. 3 is a perspective view of the telescoping vertical antenna of FIG. 1, shown collapsed but with the cap removed to show details thereof.

FIG. 4 is a front view of the telescoping vertical antenna of FIG. 1, shown fully extended.

FIG. 5 is an environmental perspective view of the telescoping vertical antenna of FIG. 1, shown mounted on a tripod.

FIG. 6 is an environmental perspective view of the telescoping vertical antenna of FIG. 1, shown mounted on an RV ladder.

Similar reference characters denote corresponding features consistently throughout the attached drawings.

### DETAILED DESCRIPTION OF THE PREFERRED EMBODIMENTS

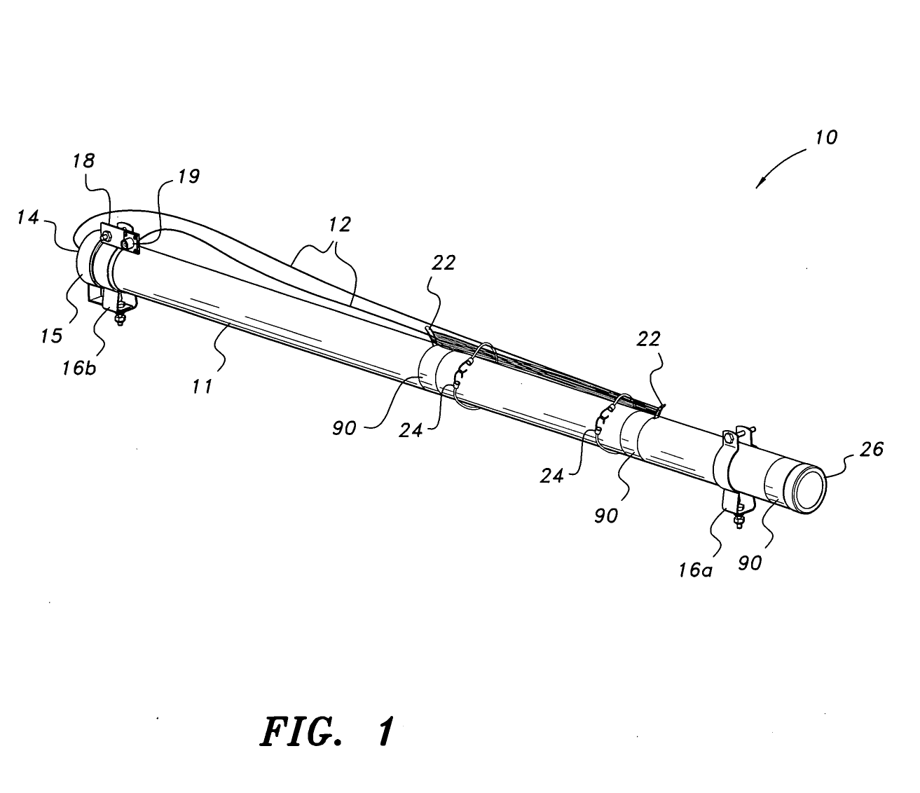

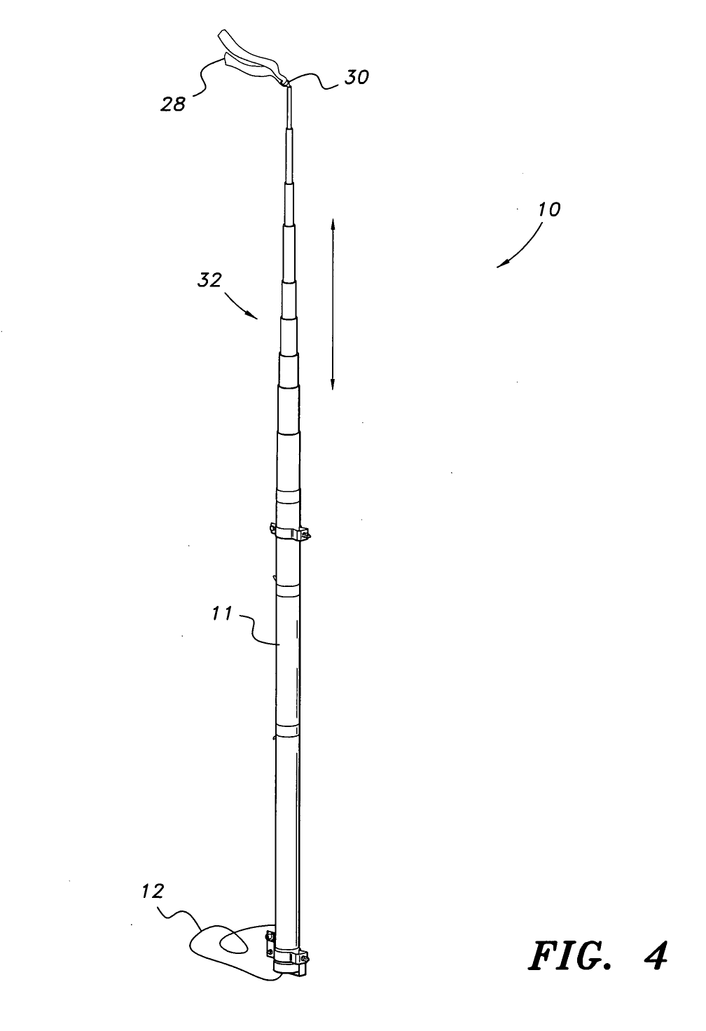

As shown in FIGS. 1 and 4, the telescoping vertical antenna 10 is made using telescoping fiberglass sections that extend the antenna up to a 31′ length. Preferably the fiberglass sections are painted a bright color with luminescent paint to help visual identification of the antenna's whereabouts during a wide variety of environmental lighting conditions. When not in use, the antenna 10 is collapsible to a length of about 44″ for storage or transport. The fiberglass pole is of a telescoping design similar to those used to support windsocks at airports and air balloon sites.

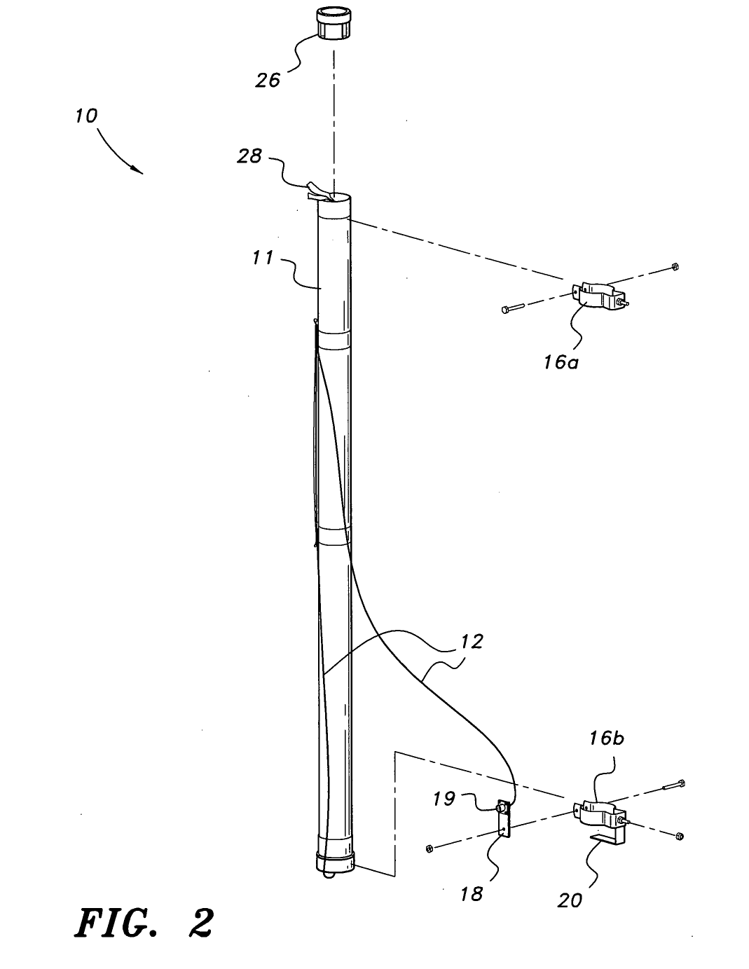

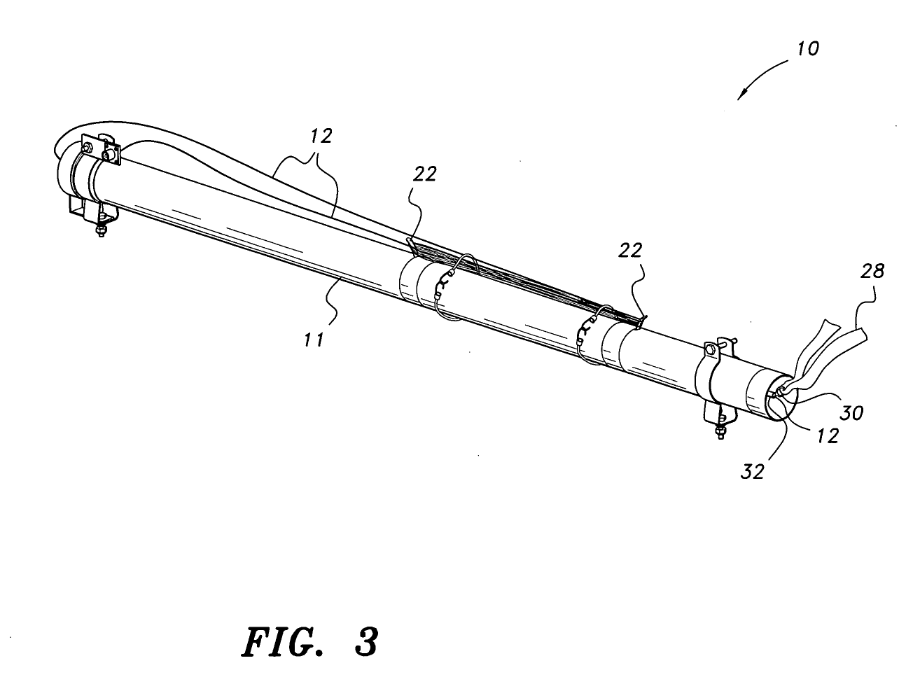

As shown in FIG. 3, the fiberglass pole of vertical antenna 10 has a plurality of telescoping, concentric, extendable hollow or tubular sections 32, including outermost base tube 11. Referring again to FIGS. 1-2, the electromagnetic receiving and radiating element is a flexible wire radiator 12, preferably having a plurality of woven strands, the wire 12 being disposed inside the innermost tube of hollow tubular sections 32 and exiting the antenna structure through a hole 14 in cap 15 attached to the bottom of tube 11. The wire 12 is preferably flexweave wire #14, either FW14P or FW14BK. Flexweave wire may generally be described as stranded wire encased in PVC insulation, and is widely used in antenna construction.

The external end of the radiator wire 12 is electrically connected to an SO-239 coaxial cable connector 19. The cable connector 19 is attached to a mounting plate 18 that extends from clamp 16b. A wire lug 30 is soldered to or otherwise attached to the internal end of flexible wire cable 12 to keep the internal portion of wire cable 12 from being retracted out of the innermost of tube sections 32. A pull ribbon 28 is attached to the wire lug 30 to assist in pulling the innermost telescoping section out for deployment of the antenna 10. A cap 26 covers top opening in tube 11 when the inner tubular sections 32 are retracted.

When the antenna 10 is in a stowed, non-operational configuration, the excess wire radiator 12 can be neatly wrapped around wire retaining prongs 22 on the outside of tube 11. The wire retaining prongs 22 may be further secured to the tube 11 by several layers of adhesive tape 90 wrapped around the tube 11 over a portion of the prongs 22. The wrapped wire is further secured through the use of short bungee cords 24, which are looped around the tube 11 over the wrapped portion of antenna wire 12.

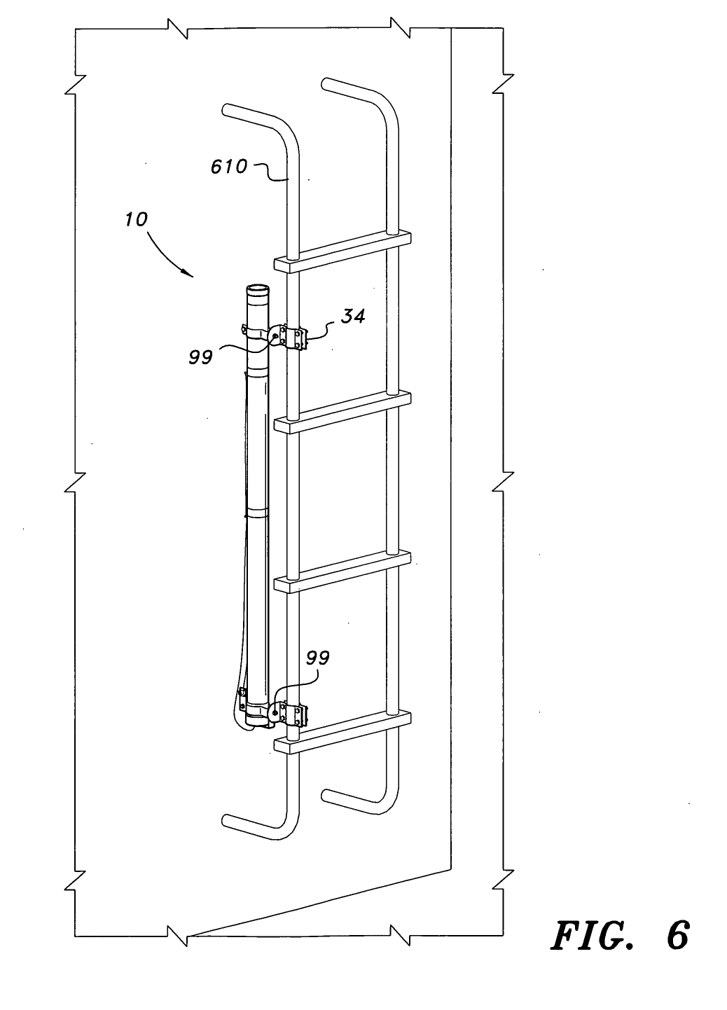

Substantially cylindrical pole clamps 16a and 16b are provided to facilitate mounting of the telescoping vertical antenna 10 on a mast or, alternatively, on mounting pipes, on an RV ladder, or the like. The antenna 10 has pole clamps 16a and 16b having a planar portion that accepts a threaded fastener to which additional clamps can be attached, and a lock nut 99 (shown in FIG. 6) can be threaded onto the fastener to secure the antenna 10 to a wide variety of support structures. Additionally, clamp 16b holds an L-shaped bracket 20 that secures the bottom end cap 15 to bottom of tube 11.

The structure of antenna 10 is preferably extendable to approximately 31′. A desired length of the structure is maintained by a moderate friction fit among tube elements 32 and between penultimate tube element 32 and outer base tube 11 as the fiberglass pole is extended. The length of antenna wire 12 is preferably about 33′, or more exactly, 32.5′. The antenna 10 is used with an antenna tuner to tune the antenna to resonance on the desired band and frequency. With a suitable tuner, such as the ICOM® AH-4 tuner, the antenna will function from the 80-meter wavelength band thru the 10-meter wavelength band. Moreover, the antenna 10 can function with either an automatic tuner or a manual tuner. A 28-foot long version of the antenna 10 functions on the 2-meter wavelength band, as well as the 440 MHz band.

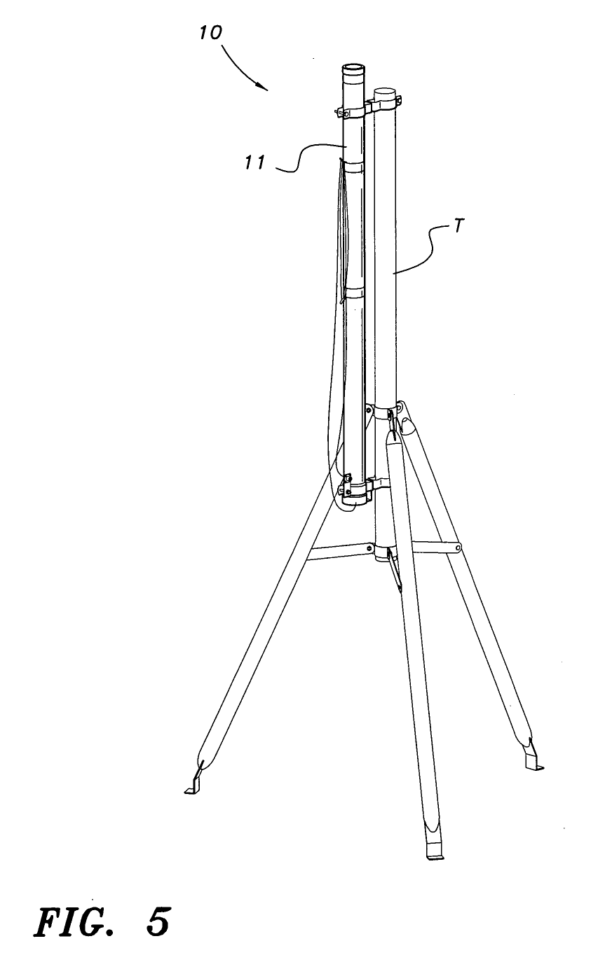

As shown in FIG. 5, a tripod T is also provided to fulfill a long felt need in the amateur radio community for a portable vertical antenna that can easily be erected in a yard. Preferably, a 1½″ diameter tripod T is used to give support to the antenna 10. The antenna 10 is mounted to the mast portion of tripod T, utilizing the cylindrical pole clamps 16a and 16b and additional mounting hardware attached to the clamps.

Double clamps are provided to facilitate a variety of mounting options, including mounting on a roof or on the ground. As with any vertical antenna, a suitable ground plane, e.g., radial wires, is needed. With the AH-4 tuner, it only required 10-feet of radial wire off each let to make a good ground plane. The tripod T can be fastened to a roof having ground wires laid out on the roof, one of the ground wires being connected to a ground rod for safety and better ground base.

Additionally, as shown in FIG. 6, the antenna 10 can be mounted on an RV ladder 610 using a combination of pole clamps 16a, 16b, and additional mounting hardware 34 (additional clamps attached to the pole clamps 16a and 16b).

It is to be understood that the present invention is not limited to the embodiment described above, but encompasses any and all embodiments within the scope of the following claims.

I claim:

1. A telescoping vertical antenna, comprising:
an elongate tube made from electrically non-conductive material, the tube having a plurality of concentrically arranged telescoping sections including a base section, a top section, and a plurality of intermediate sections, the tube being extendable to an extended position for use and retractable to a collapsed position for storage and transport, adjacent sections of the tube forming a friction fit when the tube is in the extended position;
a flexible wire radiator having a first end connected to the top section of the tube and a second end extending from the bottom tube, the radiator extending through the telescoping sections of the tube;
a top cap removably attached to the top section of the tube;
a top pole bracket disposed on the tube adjacent the top cap;
a bottom pole bracket disposed on the bottom section of the tube;
a connector support plate attached to the bottom pole bracket;
a female coaxial connector attached to the connector support plate;
a bottom cap having a hole defined therein, the bottom cap being attached to the bottom section of the tube, the wire radiator being drawn through the hole in the bottom cap, the second end of the wire radiator being electrically connected to the female coaxial connector;
an L-bracket attached to the bottom section of the tube, the L-bracket having a first arm extending beneath the bottom cap and a second arm attached to the bottom pole bracket; and
a pair of wire wrapping prongs attached to the tube along its length, the wire wrapping prongs facilitating storage of the wire radiator on the tube when the tube is in the collapsed position.

2. The telescoping vertical antenna according to claim 1, further comprising a lug attached to the top section, the wire radiator being attached to the lug.

3. The telescoping vertical antenna according to claim 2, further comprising a pull ribbon attached to said lug for facilitating extension of the tube.

4. The telescoping vertical antenna according to claim 1, further comprising layers of adhesive tape wrapped around the tube, the tape covering a portion of the wire wrapping prongs in order to attach the prongs to the tube.

5. The telescoping vertical antenna according to claim 1, further comprising a plurality of bungee clamps removably securing the wire radiator to the tube for storage and transport.

6. The telescoping vertical antenna according to claim 1, further comprising a tripod and a mast, said pole brackets releasably attaching the tube to the mast.

7. The telescoping vertical antenna according to claim 1, wherein the tube is made of fiberglass material.

8. The telescoping vertical antenna according to claim 1, wherein the tube has a length of about thirty-one feet when fully extended.

9. The telescoping vertical antenna according to claim 1, wherein the wire radiator is made from flexweave wire.

10. The telescoping vertical antenna according to claim 1, further comprising bright, luminescent paint coating the tube.
